(19) United States
(12) Patent Application Publication
(10) Pub. No.: US 2020/0198162 A1
(43) Pub. Date: Jun. 25, 2020

(54) UNIVERSAL RAZOR HANDLE SYSTEM

(71) Applicant: Best Buy Imports, Inc., Vernon, CA (US)

(72) Inventor: Ben Makabi, Vernon, CA (US)

(21) Appl. No.: 16/554,147

(22) Filed: Aug. 28, 2019

Related U.S. Application Data
(60) Provisional application No. 62/784,184, filed on Dec. 21, 2018.

(51) Int. Cl. B26B 21/52

(52) U.S. Cl. CPC B26B 21/523; B26B 21/525; B26B 21/521

(57) ABSTRACT

A razor system for shaving body hair comprising a handle portion comprising a coupler, and a head portion, wherein the coupler is configured to removably couple the handle portion with the head portion. A razor system comprising a handle portion, the handle portion comprising a threaded coupler, a straight razor slot, a straight razor blade pivotally coupled with a portion of the handle, wherein a portion of the straight razor blade fits inside a straight razor slot of the handle portion, and a head portion wherein the head portion comprises a safety razor head or a razor cartridge head configured to couple with a razor cartridge, wherein the threaded coupler is configured to removably couple the handle portion with the head portion.

### CROSS-REFERENCE TO RELATED APPLICATIONS

This application claims priority to U.S. provisional patent application No. 62/784,184 filed Dec. 21, 2018; the disclosure of which is incorporated hereby by reference.

### FIELD OF THE DISCLOSURE

The present disclosure provides a universal razor system for shaving.

### BACKGROUND

Razor handles generally are compatible with one type of replaceable razor cartridge. Most companies have a proprietary and/or unique mechanism for removably attaching razor cartridges to the razor handle. This limits a razor handle to a single type of razor blades/cartridges when replacement is necessary.

Straight razors and safety razors are a classic shaving tools used by people over the years.

An objective of the present disclosure is to provide a razor system that can adapt to be used with multiple different types of razor cartridges without requiring different razor handles and also include a straight razor for instances where a user desires that type of razor.

### SUMMARY OF THE DISCLOSURE

The present disclosure provides a solution to the limitation of a single razor cartridge fitting onto type of razor handle and also providing a straight razor as part of the razor system.

The embodiments described herein enable the user to combine different razor head elements with a razor handle to allow the use of different razor blades (i.e., cartridges, razor cartridges) and also have a straight razor.

In one embodiment, a razor system for shaving body hair can comprise a handle portion comprising a coupler, and a head portion, wherein the coupler is configured to removably couple the handle portion with the head portion.

In another embodiment, a razor system can comprise a handle portion comprises a threaded coupler, a straight razor slot, a straight razor blade pivotally coupled with a portion of the handle, wherein a portion of the straight razor blade fits inside a straight razor slot of the handle portion, and a head portion wherein the head portion comprises a safety razor head or a razor cartridge head configured to couple with a razor cartridge, wherein the threaded coupler is configured to removably couple the handle portion with the head portion.

In yet another embodiment, a razor system can comprise razor system comprising a handle portion with a threaded opening, and a head portion comprising a threaded coupler, wherein the head portion is removably coupled with the handle portion where the threaded coupler is configured to couple with the threaded opening.

### BRIEF DESCRIPTION OF THE DRAWINGS

FIG. 1A is an isometric view of a razor system with a safety razor head, a threaded coupler, and a straight razor coupled with the razor handle, consistent with embodiments of the present disclosure.

FIG. 1B is an isometric view of the razor system of FIG. 1A in an expanded view showing the safety razor head, the threaded coupler, and the razor handle with the straight razor in a closed position with the razor handle, consistent with embodiments of the present disclosure.

FIG. 1C is an isometric view of the razor system of FIGS. 1A-B in an expanded view showing the safety razor head, the threaded coupler, and the razor handle with the straight razor in an open position, consistent with embodiments of the present disclosure.

FIG. 2A is an isometric view of a razor system in an expanded view showing a razor cartridge head, the threaded coupler of FIGS. 1A-C, and the razor handle with the straight razor of FIGS. 1A-C in a closed position with the razor handle, consistent with embodiments of the present disclosure.

FIG. 2B is an isometric view of the razor system of FIG. 2A in an expanded view showing the safety razor head, the threaded coupler, and the razor handle with the straight razor in an open position, consistent with embodiments of the present disclosure.

FIG. 3A is an isometric view of a razor system with a safety razor head and a razor handle, consistent with embodiments of the present disclosure.

FIG. 3B is an isometric view of the razor system of FIG. 3A in an expanded view with the safety razor head and the razor handle, consistent with embodiments of the present disclosure.

FIG. 4A is an isometric view of a razor system with a razor cartridge head and the razor handle of FIGS. 3A-B, consistent with embodiments of the present disclosure.

FIG. 4B is an isometric view of the razor system of FIG. 4A in an expanded view, consistent with embodiments of the present disclosure.

### DETAILED DESCRIPTION

The present disclosure uses a razor handle that can accept different razor heads that will accept different types of razor cartridges that contain razor blades.

To enable changes in razor head, a razor handle can be configured to accept different razor heads through a coupling mechanism.

A portion of the razor handle can also contain a straight razor in some embodiments.

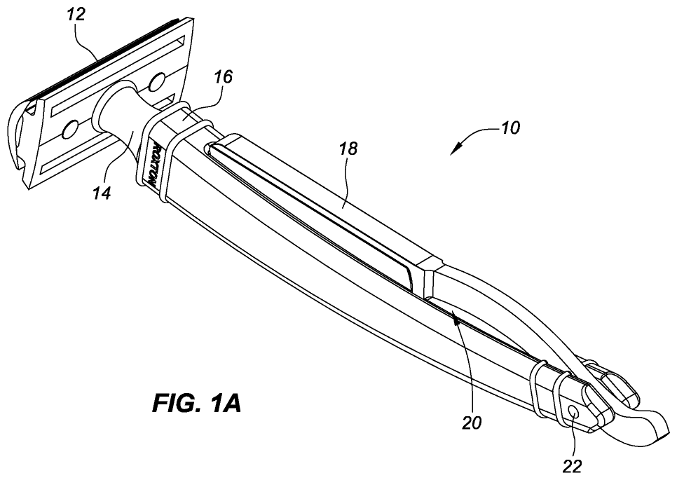

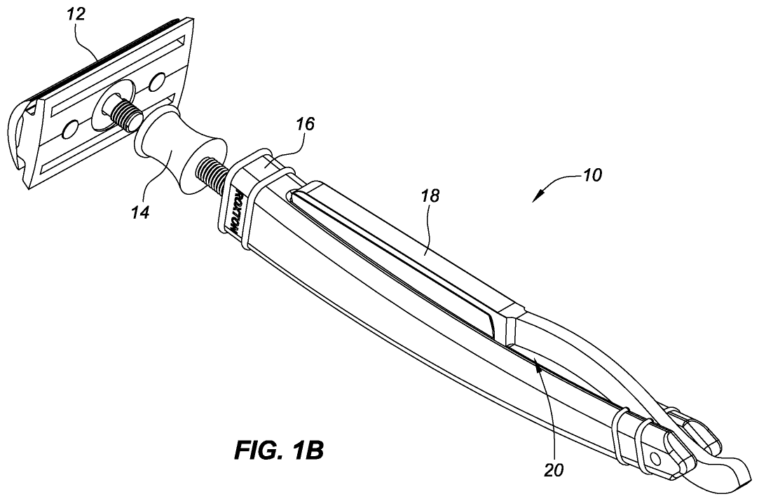

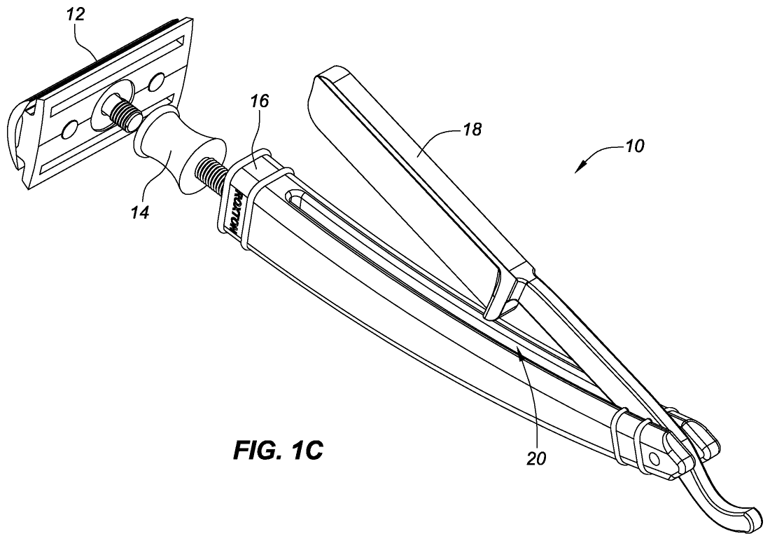

FIG. 1A is an isometric view of a safety razor head coupled with a threaded coupler ]], where the threaded coupler is coupled with a razor handle, consistent with embodiments of the present disclosure. A razor system 10 can comprise a safety razor head 12, a threaded coupler 14, and a razor handle 16. And a straight razor 18. It is beneficial and efficient for a user to have different types of razors available when shaving, including a safety razor and a straight razor.

The straight razor 18 can be pivotally coupled with the razor handle 16 and a portion of the straight razor 18 can fit within a straight razor slot 20 (i.e., recess, notch, holder, etc.) in the razor handle 16 when not in use. The straight razor 18 can pivot around a pin 22 (i.e., a fastener, a rivet, etc.) used to couple the straight razor 18 with the razor handle 16. The straight razor 18 can have a closed position (e.g., FIG. 1A, when the straight razor 18 is coupled with the straight slot 20) and an open position (e.g., when the straight razor 18 is not coupled with the straight razor slot 20). The open position can include numerous different angles between the straight razor and the handle including, for example, 60°, 90°, 110°, 130°, 150°, etc. (See FIG. 1B and related discussion for additional information).

The safety razor head 12 can be configured to accept safety razor blades (e.g., double edge razor blade, dual edge razor blades, etc.) commonly used for shaving.

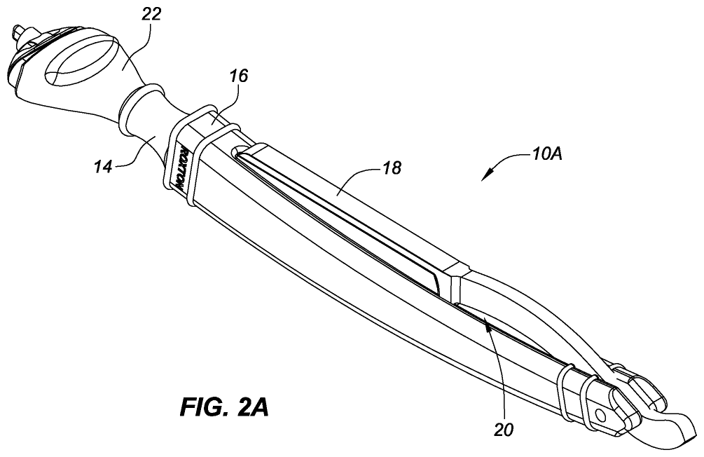

The razor handle with the safety razor head can be seen in FIGS. 1A-C (note, a replaceable safety razor blade is not shown in FIGS. 1A-C). The safety razor head 12 can be removably attached to the razor handle 10 by a threaded connection, the threaded coupler 14, or other similar mechanism. This can allow a user to remove the safety razor head 12 and replace it with a different razor head (see FIGS. 2A-C and related discussion for more information).

FIG. 2A is an isometric view of a razor system in an expanded view showing a razor cartridge head, the threaded coupler of FIGS. 1A-C, and the razor handle with the straight razor of FIGS. 1A-C in a closed position with the razor handle, consistent with embodiments of the present disclosure. A second embodiment can allow the razor handle 12 to be removably coupled with a razor cartridge head 22. The razor cartridge head 22 can be configured to accept a razor cartridge (not shown in FIGS. 2A-C) from a third party (e.g., Gillette® Fusion 5™ razor cartridge).

The razor handle 12 with the razor cartridge head 22 can be seen in FIGS. 2A-B (note, a razor cartridge is not shown in FIGS. 2A-B). The razor cartridge head 14 can be removably attached to the razor handle 12 by a threaded connection, a coupler, or other similar mechanism.

Numerous different razor cartridge head configurations are possible to allow for the use of different third party razor cartridges. For example, a razor cartridge head A can be configured to couple with razor cartridge A, a razor cartridge head B can be configured to couple with razor cartridge B, and a razor cartridge head C can be configured to couple with a razor cartridge C, etc. Other configurations of razor cartridge head are possible to allow different types of razor cartridges to be used. For example, razor cartridge heads that allow the use of other Gillette® razor blades (e.g., Sensor®, Sensor® Excel®, AtraPlus®, Mach3®, Fusion®) or other types/brands of replaceable razor cartridges.

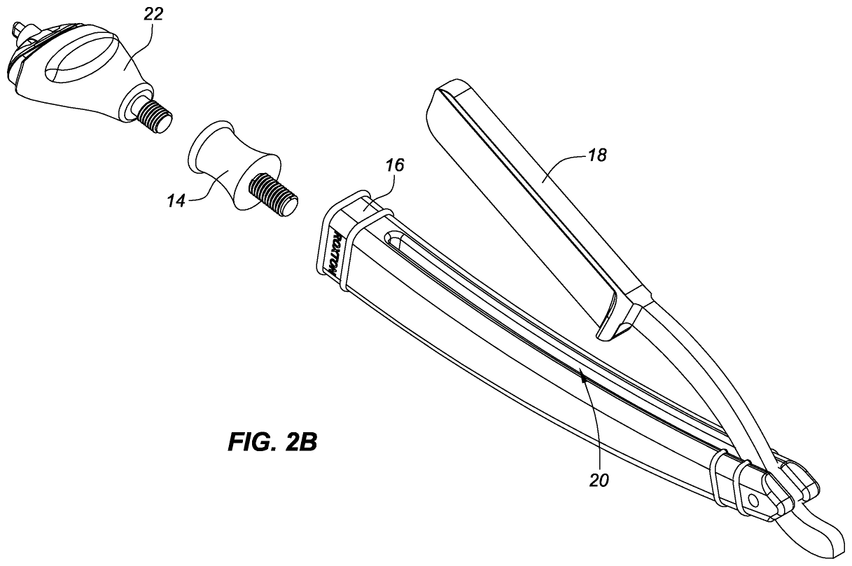

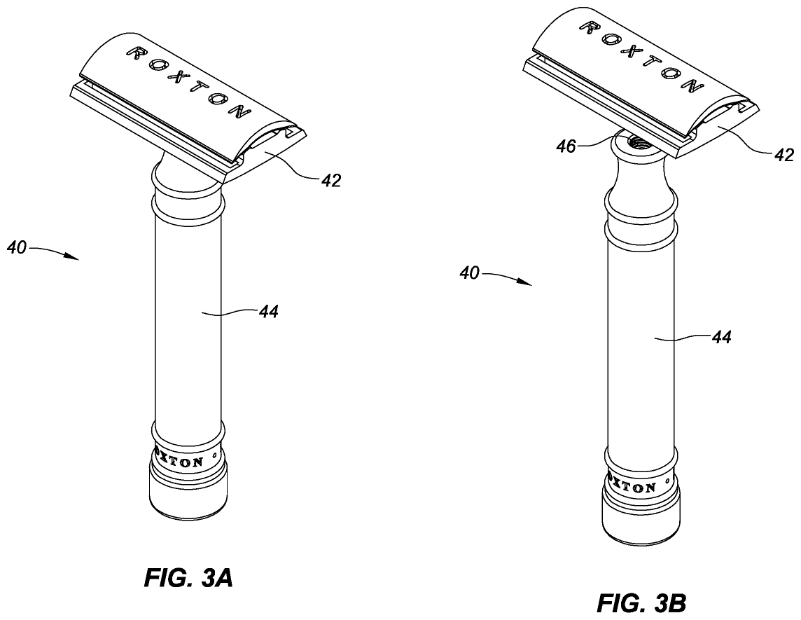

FIG. 3A is an isometric view of a razor system with a safety razor head and a razor handle 44, consistent with embodiments of the present disclosure. A razor system 40 can comprise a safety razor head 42 removably coupled with a razor handle 44. The safety razor head 42 can be coupled with the razor handle 44 using a threaded connection or other similar mechanism as described herein.

FIG. 3B is an isometric view of the razor system 40 of FIG. 3A in an expanded view with the safety razor head and the razor handle, consistent with embodiments of the present disclosure. Similar to the embodiments described and shown in FIGS. 1A-2C, an expanded view of the razor system 40 can include the safety razor head that is removably coupled with the razor handle 44. Hidden from view in FIG. 3B is a threaded portion of the safety razor head 42 that couples with a threaded opening 46 of the razor handle 44.

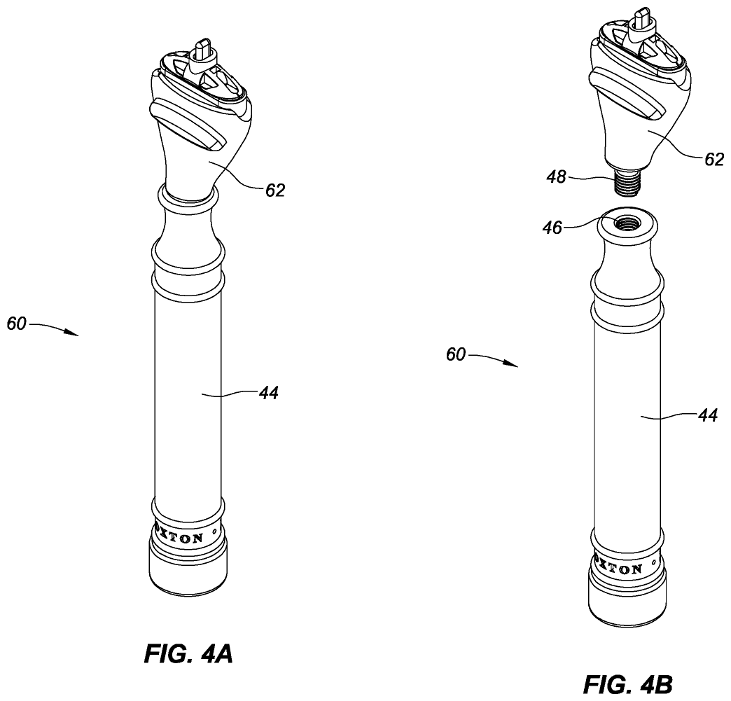

FIG. 4A is an isometric view of a razor system with a razor cartridge head and the razor handle of FIGS. 3A-B, consistent with embodiments of the present disclosure. A razor system 60 can have a razor cartridge head 62 removably coupled with the razor handle 44 of FIGS. 3A-B. It is beneficial and efficient for a user to have different types of razors available when shaving, including a razor cartridge and a straight razor. It can also be beneficial to have the ability to change out different razor cartridge heads for different types of razor cartridges due to cost considerations and/or personal preference.

FIG. 4B is an isometric view of the razor system of FIG. 4A in an expanded view, consistent with embodiments of the present disclosure. The razor system 60 can include the razor cartridge head 62 and the handle 44. The handle 44 can comprise a threaded opening (i.e., hole, aperture, etc.) 46. The razor cartridge head can comprise a threaded portion 48 that is configured to removably couple with the threaded opening 46. Other mechanisms for coupling the razor cartridge head to the handle are possible (e.g., a snap fit with a release button, etc.) two allow changing head portions of the razor system to accommodate different razor blade types.

It will be appreciated that details of the foregoing embodiments, given for purposes of illustration, are not to be construed as limiting the scope of the present disclosure. Although several embodiments of the present disclosure has been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure, which is further defined in the converted utility application and appended claims. Further, it is recognized that many embodiments may be conceived that do not achieve all the advantages of some embodiments, particularly preferred embodiments, yet the absence of a particular advantage shall not be construed to necessarily mean that such an embodiment is outside the scope of the present disclosure.

What is claimed is:

1. A razor system for shaving body hair, the razor system comprising:
a handle portion comprising a coupler; and
a head portion;
wherein the coupler is configured to removably couple the handle portion with the head portion.

2. The razor system claim 1, wherein the coupler comprises a threaded coupler.

3. The razor system of claim 2, wherein the threaded coupler is an integral element of the handle portion.

4. The razor system of claim 2, wherein the threaded coupler is a separate element from the handle portion.

5. The razor handle claim 1, wherein the head portion comprises a safety razor head or a razor cartridge head configured to removably couple with a razor cartridge.

6. The razor system of claim 1, wherein the handle portion further comprises
a straight razor slot; and
a straight razor blade pivotally coupled with a portion of the handle, wherein a portion of the straight razor blade is configured to fit inside a straight razor slot of the handle portion.

7. A razor system for shaving body hair, the razor system comprising:
a handle portion comprises:
a threaded coupler;
a straight razor slot;
a straight razor blade pivotally coupled with a portion of the handle, wherein a portion of the straight razor blade fits inside a straight razor slot of the handle portion; and
a head portion wherein the head portion comprises a safety razor head or a razor cartridge head configured to couple with a razor cartridge; and
wherein the threaded coupler is configured to removably couple the handle portion with the head portion.

8. The razor system of claim 7, wherein the threaded coupler is an integral element of the handle portion.

9. The razor system of claim 7, wherein the threaded coupler is a separate element from the handle portion.

10. A razor system for shaving body hair, the razor system comprising:
a handle portion with a threaded opening; and
a head portion comprising a threaded coupler, wherein the head portion is removably coupled with the handle portion where the threaded coupler is configured to couple with the threaded opening.

11. The razor system of claim 10, wherein the head portion comprises a safety razor head or a razor cartridge head.

12. The razor system of claim 10, wherein the safety razor head is configured to removably couple with a safety razor blade.

13. The razor system of claim 10, wherein the razor cartridge head is configured to removably couple with a razor cartridge.
